(19) United States
(12) Patent Application Publication
(10) Pub. No.: US 2010/0093474 A1
(43) Pub. Date: Apr. 15, 2010

(54) CHAIN TENSIONER

(76) Inventors: KOUICHI ONIMARU, IWATA (JP); YOSHIAKI RYOUNO, IWATA (JP)

Correspondence Address: WENDEROTH, LIND & PONACK, L.L.P., 1030 15th Street, N.W.,, Suite 400 East, Washington, DC, 20005-1503, US

(21) Appl. No.: 12/571,505

(22) Filed: Oct. 1, 2009

(30) Foreign Application Priority Data
Oct. 9, 2008 (JP) 2008-262977

(51) Int. Cl. F16H 7/08

(52) U.S. Cl. 474/110

(57) ABSTRACT

A chain tensioner includes a housing and a plunger slidably mounted in the housing. A ring receiving groove is formed in the inner periphery of the housing in which a register ring is received. The register ring is engageable in any of a plurality of circumferential grooves formed in the outer periphery of the plunger at equal axial intervals. When the plunger is pushed into the housing, the register ring is trapped between a stopper surface of the ring receiving groove and an engaging surface of one of the circumferential grooves, thereby preventing further retraction of the plunger. The register ring includes a ring portion received in the ring receiving groove and having circumferentially spaced ends, and a pair of operating pieces formed by bending the opposed ends of the ring portion to extending in the same axial direction.

### BACKGROUND OF THE INVENTION

This invention relates to a chain tensioner for keeping constant the tension of a timing chain or a timing belt for driving camshafts.

A chain transmission device is a device for transmitting the rotation of a crankshaft to camshafts through a timing belt or a timing chain (hereinafter referred only to a chain; but it should be understood that as used herein, the word “chain” encompasses a belt too). The chain transmission device includes a pivotable chain guide kept in contact with the slack side of the chain, and a chain tensioner which applied an adjusting force to the chain through the chain guide, thereby keeping constant the tension of the chain.

One known chain tensioner comprises a housing defining a cylinder chamber, a plunger mounted in the cylinder chamber, and a return spring mounted in the cylinder chamber and biasing the plunger outwardly of the housing. An oil supply passage is formed in the housing which communicates with a pressure chamber defined in the cylinder chamber behind the plunger. A check valve is provided at the oil outlet of the oil supply passage to prevent backflow of oil in the pressure chamber into the oil supply passage. Oil supplied into the pressure chamber through the oil supply passage dampens the pushing force applied to the plunger from the chain.

In this chain tensioner, when the engine stops, according to the stopped position of the cams, the tension of the chain may be kept high. Thus, after the engine has stopped, the plunger may be pushed into the housing by the chain to its stroke end.

When the engine is restarted in this state, the chain tends to slacken markedly. Thus, the plunger quickly protrudes under the biasing force of the return spring to eliminate slackness of the chain. But immediately after the engine has started, an oil pump for supplying oil into the pressure chamber is unable to deliver a sufficient amount of oil and thus unable to supply a sufficient amount of oil into the pressure chamber, of which the volume is increasing rapidly. Thus, immediately after the start of the engine, this chain tensioner cannot sufficiently perform its hydraulic dampening function.

This may cause flapping of the chain or skipping of a tooth or two of the sprockets.

In order to avoid this problem, JP Patent Publication 2006-17214A proposes to form a ring receiving groove in the inner periphery of the cylinder chamber near its open end in which a ring portion of a register ring is received. A plurality of circumferential grooves are formed in the outer periphery of the plunger at axially equal intervals. Each of the circumferential grooves comprises a tapered surface and an engaging surface extending radially outwardly from the small-diameter front end of the tapered surface. When the plunger is pushed into the housing, the register ring is configured to be trapped between the rear end surface of the ring receiving groove and the engaging surface of one of the circumferential grooves, thereby preventing any further retraction of the plunger, and thus preventing excessive slackening of the chain.

With this type of chain tensioner, because it is necessary to pull out or insert the plunger by radially expanding the ring portion of the register ring, the register ring has a pair of operating pieces provided at the respective ends of the ring portion so that by gripping the operating pieces, the ring portion can be radially expanded. A cutout is formed in the open end of the housing in which the pair of operating pieces are received.

The operating pieces disclosed in this patent publication extend in the same axial direction from the respective radially outer ends of extensions extending in the tangential directions of the ring portion so as to cross each other. Thus, the imaginary circle including the radially outer ends of the extensions has a relatively large diameter. If the outer diameter of the housing is smaller than the diameter of this imaginary circle, the operating pieces protrude from the radially outer surface of the housing, and may interfere with engine parts when mounting and dismounting the chain tensioner to and from the engine, thus making it difficult to mount and dismount the chain tensioner.

Thus, it is necessary that the housing should have an outer diameter larger than the imaginary circle including the radially outer ends of the extensions of the register ring. This makes it necessary to provide a larger and radially thicker, and thus heavier housing.

An object of the present invention is to provide a chain tensioner including a smaller and lighter housing.

### SUMMARY OF THE INVENTION

To achieve this object, the present invention provides a chain tensioner comprising a cylindrical housing having an open front end and a closed rear end, a plunger slidably mounted in the housing, a return spring mounted in the housing and biasing the plunger outwardly of the housing, wherein the plunger defines a pressure chamber in the housing, the housing being formed with an oil supply passage communicating with the pressure chamber, a check valve provided at an oil outlet of the oil supply passage to prevent backflow of oil in the pressure chamber into the oil supply passage, wherein a circumferentially extending ring receiving groove is formed in an inner periphery of the housing near the open end thereof, and a cutout is formed in the open end of the housing so as to cross the ring receiving groove, and a register ring comprising an elastically radially deformable ring portion received in the ring receiving groove and having circumferentially spaced ends, and a pair of operating pieces formed by bending the respective ends of the ring portion in an axial direction and received in the cutout, wherein a plurality of circumferential grooves are formed in an outer periphery of the plunger at axially equal intervals, each of the circumferential grooves comprising a tapered surface of which the diameter gradually decreases toward a front end of the plunger, and an engaging surface extending radially outwardly from the small-diameter front end of the tapered surface, the register ring being engageable in and radially pressed against any of the circumferential grooves, the ring receiving groove having a rear stopper surface, wherein when the plunger is pushed into the housing, the register ring is configured to be trapped between the stopper surface of the ring receiving groove and the engaging surface of one of the circumferential grooves, thereby preventing any further retraction of the plunger.

When assembling or disassembling this chain tensioner, the plunger can be inserted into or pulled out of the housing while radially expanding the ring portion of the register ring by pushing the pair of operating pieces.

The pair of operating pieces may be circular in shape, in the shape of a water drop, arcuate in shape, angular U-shaped or V-shaped, or may be straight members extending in an axial direction, or straight members extending obliquely radially outwardly from the ring portion. By bringing the opening/closing pieces at the tip of a snap ring removing tool into engagement with the operating pieces, which may be of any of the above-described shapes, from radially outside the housing, it is possible to reliably push the operating pieces apart from each other, thereby radially expanding the ring portion of the register ring.

With this arrangement, the circumscribed circle of the register ring has a smaller diameter than that of the conventional register ring in which the operating pieces extend in the same axial direction from the respective radially outer ends of extensions extending in the tangential directions of the ring portion of the register ring so as to cross each other. This makes it possible to minimize the size and weight of the housing.

### BRIEF DESCRIPTION OF THE DRAWINGS

Other features and objects of the present invention will become apparent from the following description of preferred embodiments, which is made with reference to the accompanying drawings, in which:

FIG. 1 is a sectional view of a chain tensioner embodying the present invention;

FIG. 2 is a sectional view taken along line II-II of FIG. 1;

FIG. 3 is a left-hand side view of FIG. 2;

FIG. 4 is a partial enlarged sectional view of the chain tensioner of FIG. 1, showing the register ring;

FIGS. 5 to 8 are partial side views of chain tensioners having different register rings;

FIG. 9A is a partial side view of a chain tensioner having a still different register ring;

FIG. 9B is a sectional view of FIG. 9A;

FIG. 10A is a partial side view of a chain tensioner having a yet different register ring; and

FIG. 10B is a sectional view of FIG. 10A.

### DETAILED DESCRIPTION OF THE PREFERRED EMBODIMENTS

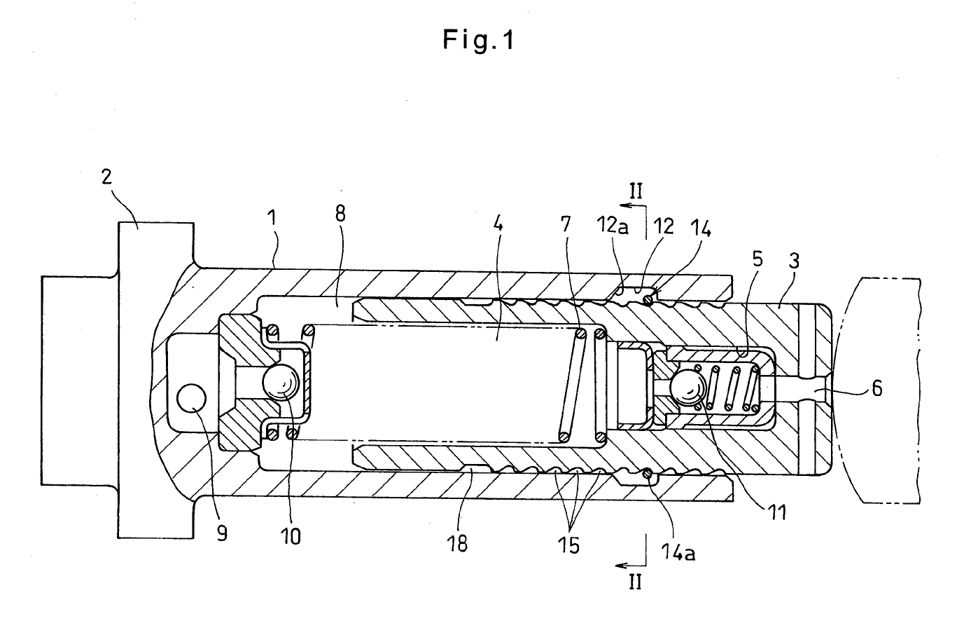

Now referring to the drawings, the embodiment of the present invention is described. As shown in FIG. 1, the chain tensioner of the embodiment comprises a cylindrical housing 1 having closed and open ends, and having a flange 2 formed on the outer periphery thereof and configured to be mounted to an engine cover.

A plunger 3 is slidably mounted in the housing 1. The plunger 3 has a spring mounting bore 4 having a rear open end and a front closed end, a valve mounting hole 5 formed in the front closed end of the spring mounting bore 4, and a pressure release hole 6 through which the valve mounting hole 5 communicates with the exterior of the housing 1. A return spring 7 is mounted between the closed end of the spring mounting bore 4 and the closed end of the housing 1. The return spring 7 biases the plunger 3 outwardly of the housing 1.

In the closed end wall of the housing 1, an oil supply passage 9 is formed which communicates with a pressure chamber 8 defined in the housing 1 behind the plunger 3. A check valve 10 is provided at the oil supply passage 9. When the pressure in the pressure chamber 8 exceeds the oil supply pressure in the oil supply passage 9, the check valve 10 is configured to close the oil supply passage 9, thereby preventing backflow of oil in the pressure chamber 8 into the oil supply passage 9.

A relief valve 11 is mounted in the valve mounting hole 5, which is formed in the plunger 3. The relief valve 11 is configured to open if the pressure in the pressure chamber 8 exceeds a set pressure, thereby discharging oil in the pressure chamber 8 to outside through the pressure release hole 6.

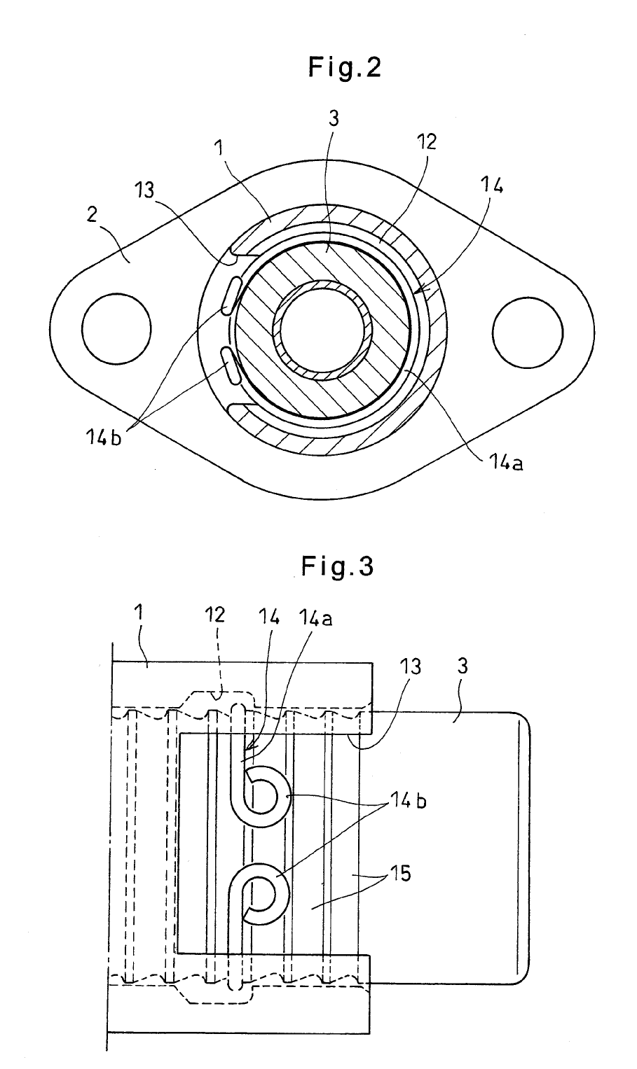

As shown in FIGS. 1 to 3, a circumferentially extending ring receiving groove 12 is formed in the inner periphery of the housing 1 near its open end. A cutout 13 is formed in the housing 1 to extend from its open end and intersect the ring receiving groove 12.

A register ring 14 comprising a wire having a circular cross-section is received in the ring receiving groove 12. The register ring 14 has an elastically radially deformable ring portion 14a having circumferentially spaced ends, and a pair of circular operating pieces 14b formed by bending the respective circumferentially spaced ends of the ring portion 14a in the same axial direction. The ring portion 14a is received in the ring receiving groove 12 with the pair of operating pieces 14b received in the cutout 13.

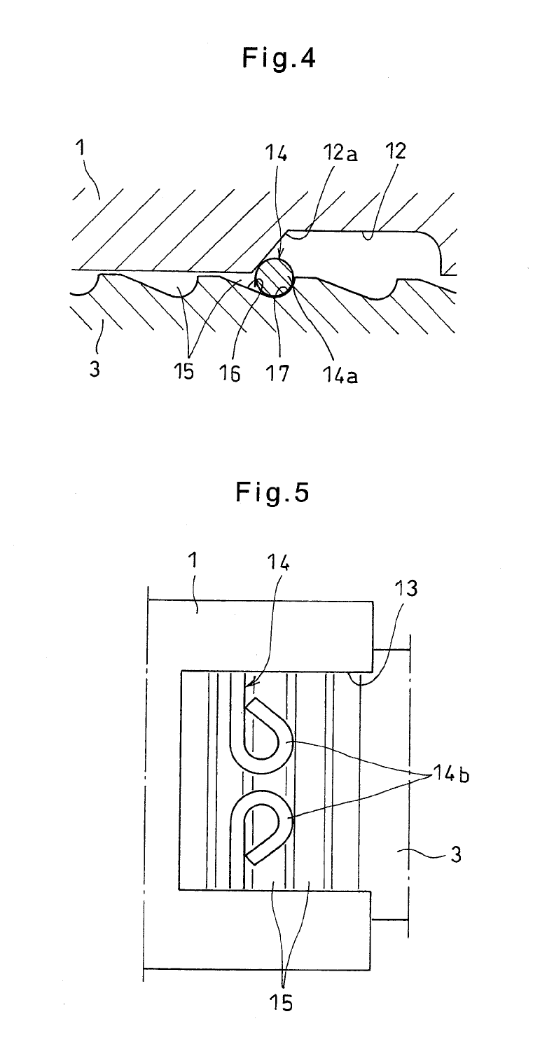

As shown in FIG. 4, a plurality of circumferential grooves 15 are formed in the outer periphery of the plunger 3 at axially equal intervals. The ring portion 14a of the register ring 14 is engageable in and radially inwardly pressed against any of the circumferential grooves 15. The circumferential grooves 15 each comprise a tapered surface 16 of which the diameter gradually decreases toward the front end of the plunger 3, and an engaging surface 17 extending radially outwardly from the small-diameter end of the tapered surface 17. The ring portion 14a of the register ring 14 slides on the tapered surface 17 while expanding radially when the plunger 3 is pushed out of the housing 1 (i.e. advances).

When a force is applied to the plunger 3 that tends to push the plunger 3 into the housing 1, the plunger 3 retracts until the ring portion 14a of the register ring 14 is trapped between the engaging surface 17 and a stopper surface 12a on the rear side of the ring receiving groove 12, thereby preventing any further retraction of the plunger 3.

As shown in FIG. 1, an anti-separation groove 18 is formed in the outer periphery of the plunger 3 at its portion nearer to the rear end of the plunger 3 than is the rearmost one of the circumferential grooves 15. By engaging in the anti-separation groove 18, the ring portion 14a of the register ring 14 prevents separation of the plunger 3 from the housing 1.

In order to adjust the tension of a camshaft driving chain using this chain tensioner, the housing 1 of the chain tensioner is inserted into a tensioner mounting hole formed in an engine cover (chain cover) from outside the engine cover, and the flange 2 is fixed to the engine cover by means of bolts such that the plunger 3 faces a pivotable chain guide kept in contact with the slack side of the chain. In this state, the plunger 3, which is biased by the return spring 7 outwardly of the housing 1, presses the chain through the chain guide, thereby increasing the tension of the chain.

FIG. 1 shows such a chain tension adjusting state. When the engine is started in this state, an oil pump (not shown) is actuated to supply oil into the pressure chamber 8 through the oil supply passage 9.

When the chain slackens in this state, the plunger 3 moves outward under the tension of the return spring 7, thus eliminating slackness of the chain.

When the plunger 3 moves outward, the ring portion 14a of the register ring 14 is allowed to slide on the tapered surface 16 of one of the circumferential grooves 15 while radially expanding. The plunger 3 can thus smoothly move outward.

When the plunger 3 moves outward by a predetermined distance, the ring portion 14a of the register ring 14 moves past the tapered surface 16 of one circumferential groove 15 and is engaged in the next circumferential groove 15.

When the tension of the chain increases, a pushing force is applied to the plunger 3 from the chain, and the pushing force is absorbed by the hydraulic dampening function of the oil in the pressure chamber 8.

If the pressure in the pressure chamber 8 exceeds the set pressure of the relief valve 11, the relief valve 11 opens, thus allowing leakage of oil in the pressure chamber 8 through the pressure release hole 6. This prevents over-tensioning of the chain.

When the pushing, force is larger than the force of the return spring 7, the ring portion 14a of the register ring 14 abuts the stopper surface 12a of the ring receiving groove 12 and is trapped between the stopper surface 12a and the engaging surface 17, thereby preventing any further retraction of the plunger 3.

Because the plunger 3 cannot retract any further once the ring portion 14a of the register ring 14 is trapped between the stopper surface 12a and the engaging surface 17, even if the tension of the chain is kept high when the engine is stopped according to the stopped positions of the cams, the plunger 3 can retract only until the ring portion 14a abuts the stopper surface 12a and never retracts markedly.

Thus, when the engine is restarted, the chain never slackens markedly, thus preventing flapping of the chain or skipping of a tooth or two of the sprockets.

When the chain is dismounted for the maintenance of the engine, the plunger 3 protrudes under the biasing force of the return spring 7. But when the plunger 3 protrudes until the anti-separation groove 18 is radially aligned with the register ring 14, the ring portion 14a of the register ring 14 is radially compressed under its own elasticity and engaged in the anti-separation groove 18, thereby preventing separation of the plunger 3 from the housing.

When assembling or disassembling the chain tensioner, the plunger 3 is inserted into or pulled out of the housing with the ring portion 14a of the register ring radially expanded. In order to radially expand the ring portion 14a, the pair of operating pieces 14b are pushed apart from each other by bringing opening/closing pieces at the tip of a snap ring-removing tool into engagement with the respective opposed portions of the operating pieces 14b. Because the operating pieces 14b are formed by bending, the opening/closing pieces at the tip of the snap ring-removing tool can be reliably brought into engagement with the respective opposed portions of the operating pieces 14b.

In the embodiment, since the register ring 14 has the elastically radially deformable ring portion 14a having circumferentially spaced ends, and the pair of circular operating pieces 14b formed by bending the respective circumferentially spaced ends of the ring portion 14a in the same axial direction, the circumscribed circle of the register ring of the embodiment has a smaller diameter than the circumscribed circle of a register ring having extensions at the respective circumferentially spaced ends of the ring portion 14a so as to extend in the tangential directions and cross each other, and operating pieces provided at the respective free ends of the extensions.

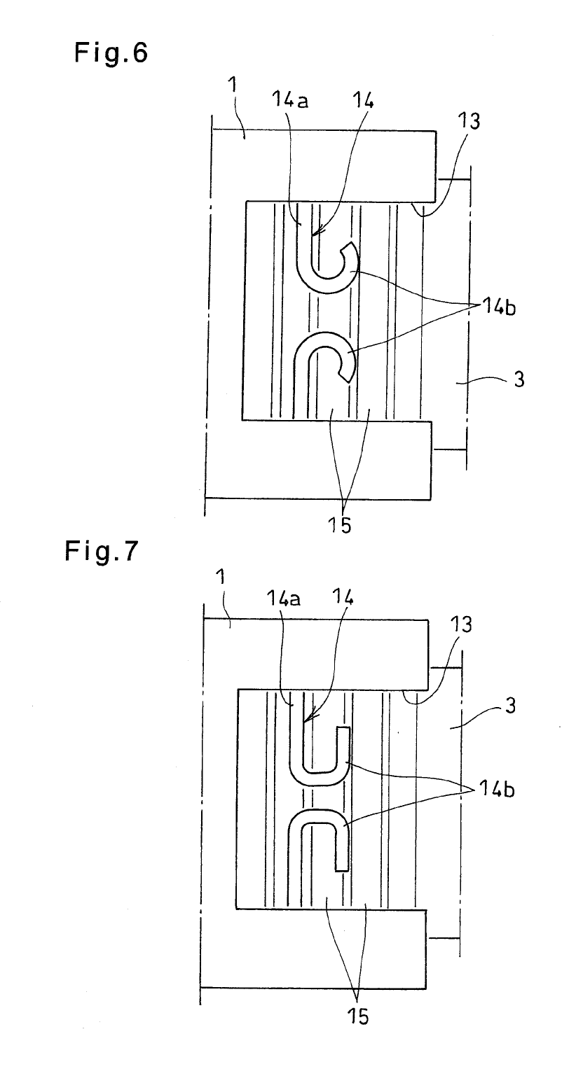

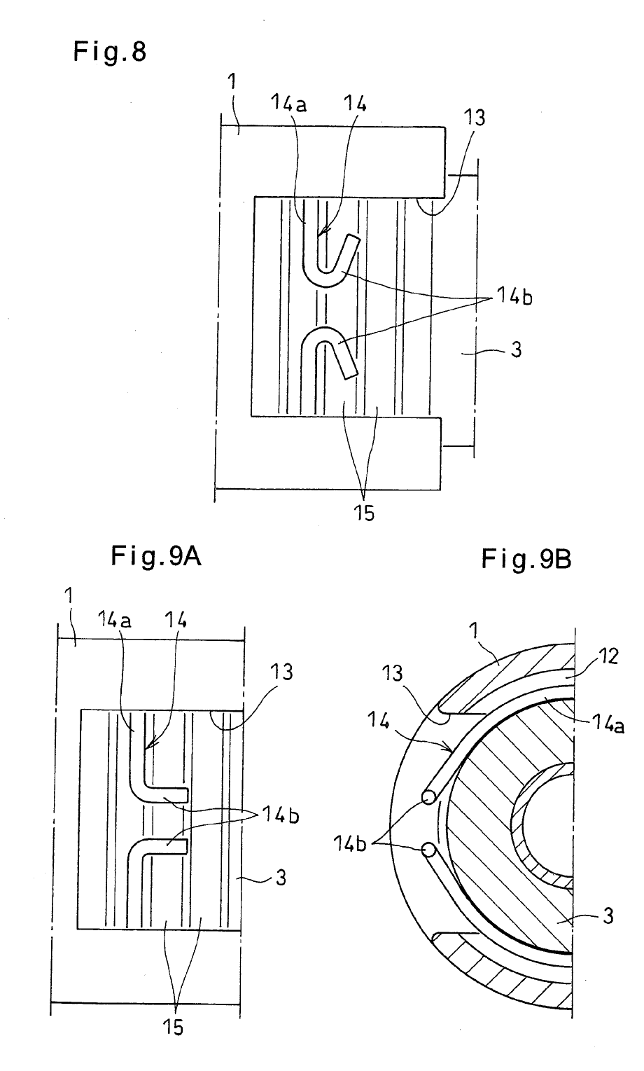

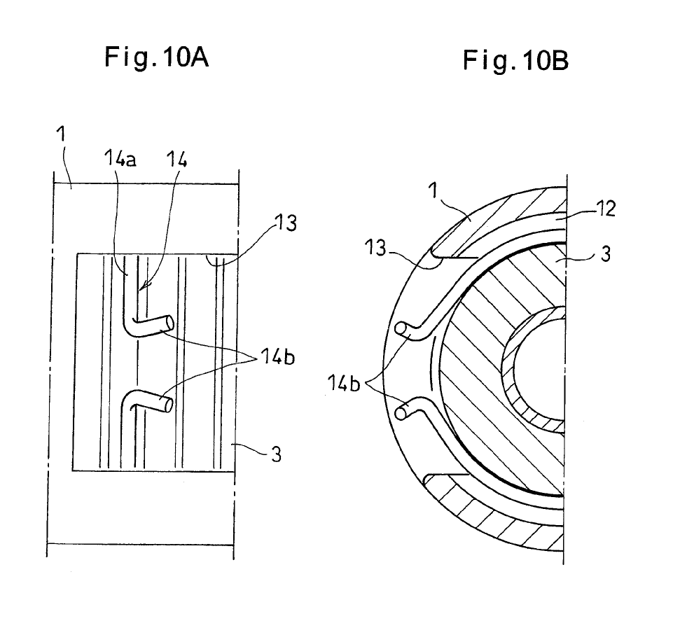

In FIG. 3, the operating pieces 14b are circular but the operating pieces according to the present invention are not limited to circular in shape, but may be of other shapes, such as shown in FIGS. 5 to 10. In particular, FIG. 5 shows operating pieces in the shape of water drops, FIG. 6 shows arcuate operating pieces, FIG. 7 shows angular U-shaped operating pieces, FIG. 8 shows V-shaped operating pieces, FIGS. 9A and 9B show straight operating pieces, FIGS. 10A and 10B show straight operating pieces extending obliquely radially outwardly from the ring portion. It is possible to bring a snap ring-removing tool into engagement with any type of these operating pieces to reliably and easily radially expand the register ring 14 from the outer periphery of the housing 1.

What is claimed is:

1. A chain tensioner comprising:
a cylindrical housing having an open front end and a closed rear end;
a plunger slidably mounted in the housing;
a return spring mounted in the housing and biasing the plunger outwardly of the housing;
wherein said plunger defines a pressure chamber in the housing, said housing being formed with an oil supply passage communicating with the pressure chamber;
a check valve provided at an oil outlet of the oil supply passage to prevent backflow of oil in the pressure chamber into the oil supply passage;
wherein a circumferentially extending ring receiving groove is formed in an inner periphery of the housing near the open end thereof, and a cutout is formed in the open end of the housing so as to cross the ring receiving groove; and
a register ring comprising an elastically radially deformable ring portion received in the ring receiving groove and having circumferentially spaced ends, and a pair of operating pieces formed by bending the respective ends of the ring portion in an axial direction and received in the cutout,
wherein a plurality of circumferential grooves are formed in an outer periphery of the plunger at axially equal intervals, each of the circumferential grooves comprising a tapered surface of which the diameter gradually decreases toward a front end of the plunger, and an engaging surface extending radially outwardly from the small-diameter front end of the tapered surface, said register ring being engageable in and radially pressed against any of the circumferential grooves, said ring receiving groove having a rear stopper surface, wherein when the plunger is pushed into the housing, the register ring is configured to be trapped between the stopper surface of the ring receiving groove and the engaging surface of one of the circumferential grooves, thereby preventing any further retraction of the plunger.

2. The chain tensioner of claim 1, wherein said pair of operating pieces are circular in shape.

3. The chain tensioner of claim 1, wherein said pair of operating pieces are in the shape of a water drop.

4. The chain tensioner of claim 1, wherein said pair of operating pieces are arcuate in shape.

5. The chain tensioner of claim 1, wherein said pair of operating pieces are angular U-shaped.

6. The chain tensioner of claim 1, wherein said pair of operating pieces are V-shaped.

7. The chain tensioner of claim 1, wherein said pair of operating pieces are straight members.

8. The chain tensioner of claim 1, wherein said pair of operating pieces are straight members extending obliquely radially outwardly from the ring portion.
